(19) United States
(12) Patent Application Publication
(10) Pub. No.: US 2024/0279507 A1
(43) Pub. Date: Aug. 22, 2024

(54) SINTER POWDER (SP) COMPRISING A THERMOPLASTIC POLYURETHANE

(71) Applicant: BASF SE, Ludwigshafen am Rhein (DE)

(72) Inventors: Stephan DOHMEN, Lemfoerde (DE); Elmar POESELT, Lemfoerde (DE); Claus GABRIEL, Ludwigshafen am Rhein (DE); Leander VERBELEN, Heidelberg (DE); Florian A. DEME, Frontonas (FR); Jocelyn SALAS LAZO, Frontonas (FR); Jean ROCHETTE, Frontonas (FR)

(21) Appl. No.: 18/571,874

(22) PCT Filed: Jun. 8, 2022
(86) PCT No.: PCT/EP2022/065608

§ 371 Date: Dec. 19, 2023

(30) Foreign Application Priority Data
Jun. 21, 2021 (EP) 21305850.6

(51) Int. Cl. C09D 175/06; B29B 13/10; B29C 64/153; B29K 75/00; B29K 105/00; B29K 105/12; B29K 105/16; B29K 307/04; B29K 309/02; B29K 309/08; B33Y 10/00; B33Y 70/00; C09D 5/03; C09D 7/61; C09D 7/63; C09D 7/65; C09D 7/80; C09D 175/08

(52) U.S. Cl. CPC C09D 175/06; B29B 13/10; B33Y 70/00; C09D 5/031; C09D 5/032; C09D 5/037; C09D 7/61; C09D 7/63; C09D 7/65; C09D 7/80; C09D 175/08; B29C 64/153; B29K 2075/00; B29K 2105/0005; B29K 2105/122; B29K 2105/16; B29K 2105/251; B29K 2307/04; B29K 2309/02; B29K 2309/08; B33Y 10/00

(57) ABSTRACT

The present invention relates to a sinter powder (SP) comprising 58.5% to 99.95% by weight of at least one thermoplastic polyurethane (A), 0.05% to 1.5% by weight of at least one flow agent (B), 0% to 5% by weight of at least one organic additive (C), 0% to 5% by weight of at least one further additive (D) and 0% to 30% by weight of at least one reinforcer (E), based in each case on the sum total of the percentages by weight (A), (B), (C), (D) and (E), wherein the thermoplastic polyurethane (A) is prepared by reacting at least one isocyanate (a), at least one isocyanate-reactive compound (b), and at least one chain extender (c), and wherein components (a), (b) and (c) each comprise not more than 15 mol-% of aromatic moieties, based on the total amount of the respective component (a), (b) and (c). The present invention further relates to a method of producing the sinter powder (SP) and to the use of the sinter powder (SP) in a three-dimensional (3D) printing process. The present invention further relates to a three-dimensional shaped article comprising the thermoplastic polyurethane (A), to a method of producing a three-dimensional shaped article and to the use of the at least one thermoplastic polyurethane (A) in a three-dimensional (3D) printing process for producing a three-dimensional shaped article to improve the energy return of the three-dimensional shaped article.

The present invention relates to a sinter powder (SP) comprising 58.5% to 99.95% by weight of at least one thermoplastic polyurethane (A), 0.05% to 1.5% by weight of at least one flow agent (B), 0% to 5% by weight of at least one organic additive (C), 0% to 5% by weight of at least one further additive (D) and 0% to 30% by weight of at least one reinforcer (E), based in each case on the sum total of the percentages by weight (A), (B), (C), (D) and (E), wherein the thermoplastic polyurethane (A) is prepared by reacting at least one isocyanate (a), at least one isocyanate-reactive compound (b), and at least one chain extender (c), and wherein components (a), (b) and (c) each comprise not more than 15 mol-% of aromatic moieties, based on the total amount of the respective component (a), (b) and (c). The present invention further relates to a method of producing the sinter powder (SP) and to the use of the sinter powder (SP) in a three-dimensional (3D) printing process. The present invention further relates to a three-dimensional shaped article comprising the thermoplastic polyurethane (A), to a method of producing a three-dimensional shaped article and to the use of the at least one thermoplastic polyurethane (A) in a three-dimensional (3D) printing process for producing a three-dimensional shaped article to improve the energy return of the three-dimensional shaped article.

The rapid provision of prototypes is a problem which has frequently occurred in recent times. One process which is particularly suitable for this so-called “rapid prototyping” is selective laser sintering (SLS). This involves selectively exposing a polymer powder in a chamber to a laser beam. The powder melts, and the molten particles coalesce and solidify again. Repeated application of polymer powder and the subsequent irradiation with a laser facilitates modeling of three-dimensional shaped bodies.

The process of selective laser sintering for the production of three-dimensional shaped bodies from pulverulent polymers is described in detail in patent applications U.S. Pat. No. 6,136,948 and WO 96/06881.

A further development of selective laser sintering is high-speed sintering (HSS), described in EP 1 648 686, or WO 2019/182579, or what is called multi-jet fusion technology (MJF) from HP. In high-speed sintering, by spray application of a fusing agent, which is typically an ink comprising at least one radiation absorber, onto the component cross section to be sintered, followed by exposure with an infrared source, a higher processing speed is achieved compared to selective laser sintering.

A further variant of sintering is the selective heat sintering (SHS) method that uses the print unit of a conventional thermal printer to selectively melt the polymer powder.

A polymer that has recently been frequently used in selective laser sintering is thermoplastic polyurethane.

US 2017/0129177 A1 discloses a thermoplastic pulverulent composition which comprises pulverulent thermoplastic polyurethane and from 0.02 to 0.5% by weight, based on the total weight of the composition, of plasticizers, for producing articles in powder-based additive manufacturing processes. The thermoplastic polyurethane comprises a reaction product of at least one organic diisocyanate, at least one compound having groups which are reactive toward isocyanate groups and a number average molecular weight MN of from 500 g/mol to 6 000 g/mol and at least one chain extender having a number average molecular weight MN of from 60 to 450 g/mol.

US 2020/0307076 A1 discloses an additive manufacturing process (3D printing) using particles having a meltable polymer. The meltable polymer comprises a thermoplastic polyurethane polymer which has a melting range (DSC, Differential Scanning calorimetry; second heating at heating rate 5 K/min) of 160 to 270° C. and a Shore D hardness according to DIN ISO 7619-1 of 50 or more and which, at a temperature T, has a melt volume rate (melt volume rate (MVR)) according to ISO 1133:2012-02 of 5 to 15 cm³/10 min and a change of the MVR, when this temperature T increases by 20° C., of greater than or equal to 90 cm³/10 min.

WO 2015/109143 A1 discloses systems and methods for solid freeform fabrication, especially selective laser sintering, as well as various articles made using the same, where the systems and methods utilize thermoplastic polyurethanes. The thermoplastic polyurethanes are derived from (a) a polyisocyanate component, (b) a polyol component, and (c) an optional chain extender component; wherein the resulting thermoplastic polyurethane has a melting enthalpy of at least 5.5 J/g, a Tc (crystallization temperature) of more than 70 C, a Δ(Tm:Tc) of from 20 to 75 degrees, where Δ(Tm:Tc) is the difference between the Tm (melting temperature) and Tc.

WO 2020/149848 A1 discloses a materials kit for three-dimensional (3D) printing comprising a powder bed material comprising thermoplastic polyurethane particles having an average particle size from about 20 μm to about 120 μm and a melting temperature of from about 100° C. to about 250° C., wherein the thermoplastic polyurethane particles include polyurethane polymer strands having an average of about 10 wt % to about 30 wt % hard segments, based on a total weight of the thermoplastic polyurethane particles, the hard segments including a symmetrical aliphatic diisocyanate and a symmetrical aliphatic chain extender that are polymerized into the thermoplastic polyurethane particles, and a fusing agent comprising a radiation absorber to selectively apply to the powder bed material.

EP 3 540 012 A1 discloses systems and methods for solid freeform fabrication, especially fused deposition modeling, as well as various articles made using the same, where the systems and methods utilize thermoplastic polyurethanes. The thermoplastic polyurethanes are derived from (a) a polyisocyanate component, (b) a polyol component, and (c) an optional chain extender component where the resulting thermoplastic polyurethane has a crystallization temperature above 80° C. and retains more than 20% of its shear storage modulus at 100° C. relative to its shear storage modulus at 20° C.

A disadvantage of the three-dimensional shaped articles obtained from sinter powders of the state of the art comprising thermoplastic polyurethanes, however, is that they either have a high energy return but a low E-modulus or a high E-modulus but a low energy return. However, for some applications, for example in the footwear market, it is important that the three-dimensional shaped articles obtained from sinter powders show both a high energy return and a high E-modulus.

It is thus an object of the present invention to provide a sinter powder which, in a method of producing three-dimensional shaped bodies by a three-dimensional printing process, has the aforementioned disadvantages of the sinter powders and methods described in the prior art only to a small degree, if at all. The sinter powder and the method should respectively be producible and performable in a very simple and inexpensive manner.

This object is achieved by a sinter powder (SP) comprising the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c).

It has been found that, surprisingly, a three-dimensional shaped article obtained by a three-dimensional (3D) printing process using the sinter powder (SP) shows both a high energy return as well as a high E-modulus. The energy return of the three-dimensional shaped article is preferably ≥55%, more preferably ≥60%, most preferably ≥62%, and especially preferably ≥65%, determined according to DIN 53512 on a 3D-printed full disk with ratios as defined in the norm, and the E-modulus is preferably in the range of 92 to 300 MPa, more preferably in the range of 95 to 280 MPa, and most preferably in the range of 100 to 270 MPa, determined according to ISO 527-1: 2019-09, type 1A tensile bar.

Furthermore, the three-dimensional shaped articles show a high elongation at break, preferably of ≥50%, more preferably of ≥150%, and most preferably of ≥200%, also determined according to ISO 527-1: 2019-09, type 1A tensile bar.

### Sinter Powder (SP)

According to the invention, the sinter powder (SP) comprises as component (A) 58.5% to 99.95% by weight of at least one thermoplastic polyurethane, as component (B) 0.05% to 1.5% by weight of at least one flow agent, as component (C) 0% to 5% by weight of at least one organic additive (C), as component (D) 0% to 5% by weight of at least one further additive (D), and as component (E) 0% to 30% by weight of at least one reinforcer (E), based in each case on the sum total of the percentages by weight of (A), (B), (C), (D) and (E), preferably based on the total weight of the sinter powder (SP).

The percentages by weight of components (A), (B), (C), (D) and (E) typically add up to 100% by weight.

In the context of the present invention the terms “component (A)” and “at least one thermoplastic polyurethane” are used synonymously and therefore have the same meaning.

The same applies to the terms “component (B)” and “at least one flow agent”. These terms are likewise used synonymously in the context of the present invention and therefore have the same meaning.

Correspondingly, the terms “component (C)” and “at least one organic additive” are also used synonymously and have the same meaning.

The terms “component (D)” and “at least one further additive”, and “component (E)” and “at least one reinforcer”, are also each used synonymously in the context of the present invention and therefore have the same meaning.

The sinter powder (SP) preferably comprises in the range from 73.3% to 99.9% by weight of component (A), in the range from 0.1% to 1.2% by weight of component (B), in the range from 0% to 3% by weight of component (C), in the range from 0% to 2.5% by weight of component (D) and in the range from 0% to 20% by weight of component (E), based in each case on the sum total of the percentages by weight of components (A), (B), (C), (D) and (E), preferably based on the total weight of the sinter powder (SP).

The sinter powder (SP) most preferably comprises in the range from 74.9% to 99.8% by weight of component (A), in the range from 0.2% to 1.1% by weight of component (B), in the range from 0% to 1.5% by weight of component (C), in the range from 0% to 2.5% by weight of component (D) and in the range from 0% to 20% by weight of component (E), based in each case on the sum total of the percentages by weight of components (A), (B), (C), (D) and (E), preferably based on the total weight of the sinter powder (SP).

The sinter powder (SP) particularly preferably comprises in the range from 75.4% to 99.75% by weight of component (A), in the range from 0.25% to 1.0% by weight of component (B), in the range from 0% to 1.1% by weight of component (C), in the range from 0% to 2.5% by weight of component (D) and in the range from 0% to 20% by weight of component (E), based in each case on the sum total of the percentages by weight of components (A), (B), (C), (D) and (E), preferably based on the total weight of the sinter powder (SP).

If the sinter powder (SP) comprises component (C), it may comprise, for example, in the range from 0.1% to 5% by weight of component (C), preferably in the range from 0.1% to 3% by weight of component (C), more preferably in the range from 0.3% to 1.5% by weight of component (C), and particularly preferably in the range from 0.5% to 1.1% by weight of component (C), based on the sum total of the percentages by weight of components (A), (B), (C), (D) and (E), preferably based on the total weight of the sinter powder (SP).

If the sinter powder (SP) comprises component (D), it may comprise, for example, in the range from 0.1% to 5% by weight of component (D), preferably in the range from 0.2% to 2.5% by weight of component (D), based on the sum total of the percentages by weight of components (A), (B), (C), (D) and (E), preferably based on the total weight of the sinter powder (SP).

If the sinter powder (SP) comprises component (E), it may comprise, for example, in the range from 5% to 30% by weight of component (E), preferably in the range from 10% to 20% by weight of component (E), based on the sum total of the percentages by weight of components (A), (B), (C), (D) and (E), preferably based on the total weight of the sinter powder (SP).

If the sinter powder (SP) comprises component (C), component (D) and/or component (E), the percentages by weight of the at least one thermoplastic polyurethane (A) present in the sinter powder (SP) are typically correspondingly reduced, such that the sum total of the percentages by weight of the at least one thermoplastic polyurethane (A) and of component (B), as well as of component (C), component (D) and/or of component (E) adds up to 100% by weight.

If the sinter powder (SP) comprises components (C) and (D), it thus comprises, for example, in the range from 58.5% to 99.75% by weight of component (A), in the range from 0.05% to 1.5% by weight of component (B), in the range from 0.1% to 5% by weight of component (C), in the range from 0.1% to 5% by weight of component (D) and in the range from 0% to 30% by weight of component (E), based on the sum total of the percentages by weight of components (A), (B), (C), (D) and (E), preferably based on the total weight of the sinter powder (SP).

The sinter powder (SP) typically comprises particles. These particles have, for example, a size (D50) in the range from 10 to 150 μm, preferably in the range from 15 to 130 μm, more preferably in the range from 20 to 110 μm and especially preferably in the range from 40 to 100 μm.

In the context of the present invention, the “D50” is to be understood to mean the particle size at which 50% by volume of the particles based on the total volume of the particles are smaller than or equal to the D50 and 50% by volume of the particles based on the total volume of the particles are larger than the D50.

The D50 is determined in the context of the present invention by means of laser diffraction to ISO 13320: 2020-01 (Mastersizer 3000, Malvern Panalytical) with dry dispersion at 4 bar. The evaluation is effected with the aid of the Mie Theory.

The particles also have, for example, a size (D10) in the range from 10 to 70 μm, preferably in the range from 15 to 60 μm, and more preferably in the range from 20 to 40 μm.

In the context of the present invention, the “D10” is to be understood to mean the particle size at which 10% by volume of the particles based on the total volume of the particles are smaller than or equal to the D10 and 90% by volume of the particles based on the total volume of the particles are larger than the D10.

The D10 is also determined in the context of the present invention by means of laser diffraction to ISO 13320: 2020-01 (Mastersizer 3000, Malvern Panalytical) with dry dispersion at 4 bar. The evaluation is effected with the aid of the Mie Theory.

The particles also have, for example, a size (D90) in the range from 50 to 210 μm, preferably in the range from 80 to 200 μm, and more preferably in the range from 80 to 180 μm.

In the context of the present invention, the “D90” is to be understood to mean the particle size at which 90% by volume of the particles based on the total volume of the particles are smaller than or equal to the D90 and 10% by volume of the particles based on the total volume of the particles are larger than the D90.

The D90 is also determined in the context of the present invention by means of laser diffraction to ISO 13320:2020-01 (Mastersizer 3000, Malvern Panalytical) with dry dispersion at 4 bar. The evaluation is effected with the aid of the Mie Theory.

The sinter powder (SP) typically has a melting temperature (T_{M(SP), H1}) in the range from 90 to 220° C. Preferably, the melting temperature (T_{M(SP), H1}) of the sinter powder (SP) is in the range from 100 to 190° C., more preferably in the range from 120 to 170° C. and especially preferably in the range from 128 to 168° C.

The sinter powder (SP) also typically has a melting temperature (T_{M(SP), H2}) in the range from 120 to 180° C. Preferably, the melting temperature (T_{M(SP), H2}) of the sinter powder (SP) is in the range from 125 to 175° C., more preferably in the range from 130 to 175° C. and especially preferably in the range from 135 to 165° C.

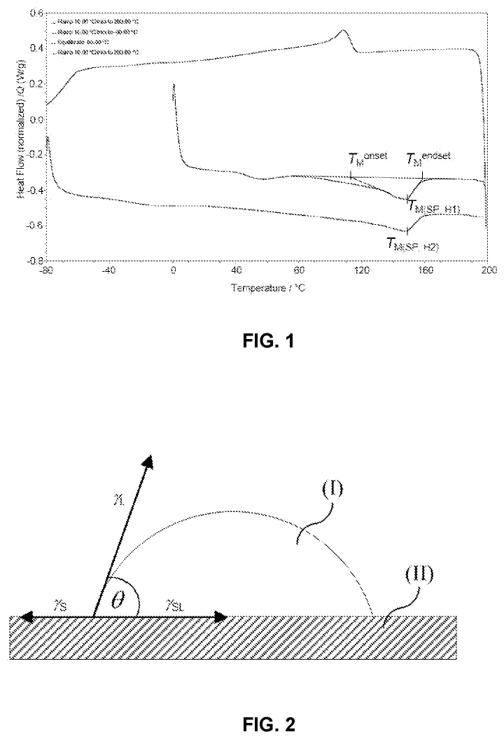

In the context of the present invention, the melting temperatures (T_{M(SP), H1}) and (T_{M(SP), H2}) are determined according to DIN EN ISO 11357-3: 2018-04 by means of differential scanning calorimetry (DSC; Discovery series DSC, TA Instruments). During the measurement under a nitrogen atmosphere, the sample is subjected to the following temperature cycle: equilibrate at 0° C., then heating to at least 200° C. at 10° C./min (1st heating run (H1)), then cooling to −80° C. at 10° C./min, then equilibrate at −80° C., then heating to at least 200° C. at 10° C./min (2nd heating run (H2)). This affords a DSC diagram as shown by way of example in FIG. 1. The terms “melt onset (T_{M}^{onset})” and “melt endset (T_{M}^{endset})” are known to the person skilled in the art. They respectively correspond to the start (onset) and the end (endset) of the melting peak. The melting temperature (T_{M(SP), H1}) is understood to mean the temperature at which the melting peak of the first heating run (H1) of the DSC diagram has a maximum and the melting temperature (T_{M(SP), H2}) IS understood to mean the temperature at which the melting peak of the second heating run (H2) of the DSC diagram has a maximum. The first heating run of the DSC of the TPU according to the invention may show more than one melting peak, which are presented by several maxima in the DSC graph. In this case (T_{M(SP), H1}) is understood as the maximum of the melting peak having the highest melting temperature.

The sinter powder (SP) typically also has a bulk density in the range from 250 to 700 g/L, preferably in the range from 280 to 600 g/L, and more preferably in the range from 310 to 580 g/L.

In the context of the present invention, the bulk density is determined according to DIN EN ISO 60: 2000-01. It may be used as a measure of the flowability of the sinter powder (SP). The higher the bulk density, the higher the flowability of the sinter powder (SP).

The sinter powder (SP) also usually has a melt flow rate (MFR) in the range of 1 to 75 g/10 min. Preferably, the melt flow rate of the sinter powder (SP) is in the range of 10 to 70 g/10 min, more preferably in the range of 20 to 65 g/10 min, and most preferably in the range of 30 to 60 g/10 min.

In the context of the present invention, the melt flow rate (MFR) is determined according to DIN EN ISO 1133-1: 2012-02, Part 1; Method B. For this purpose, the sinter powder (SP) is pre-dried for 3 hours at 100° C. in nitrogen and then measured with a load of 2.16 kg and at a temperature of 190° C.

The sinter powder (SP) can be produced by any methods known to those skilled in the art. For example, the sinter powder is produced by grinding, by precipitation, by melt emulsification or by microgranulation.

If the sinter powder (SP) is produced by precipitation, component (A) is typically mixed with a solvent and dissolved in the solvent, optionally while heating, to obtain a solution. The TPU powder is subsequently precipitated, for example by cooling the solution, distilling the solvent out of the solution or adding a precipitant to the solution. Component (B) and optionally components (C), (D) and (E) are typically mixed into the dry TPU powder to obtain the sinter powder (SP).

The grinding can be conducted by any methods known to those skilled in the art; for example, components (A), (B) and optionally (C), (D) and (E) are introduced into a mill and ground therein.

Suitable mills include all mills known to those skilled in the art, for example classifier mills, counter-jet mills, hammer mills, ball mills, vibrating mills or rotor mills such as pin mills and eddy current mills. The particle size is typically adjusted by a sieving device arranged downstream of the mill. In a preferred embodiment, a long mesh sieve is used. The use of a long mesh sieve increases the yield of the usable material fraction. The mesh size of the sieve is selected in a manner, that the above-mentioned D50 value of the sinter powder (SP) can be achieved.

The grinding in the mill can likewise be effected by any methods known to those skilled in the art. For example, the grinding can take place under inert gas and/or while cooling with liquid nitrogen. Cooling with liquid nitrogen is preferred. The temperature during grinding can be arbitrary; the grinding is preferably carried out at liquid nitrogen temperatures, for example at a temperature in the range from −210 to −195° C. The temperature of the components during grinding is then, for example, in the range from −60 to 0° C.

The thermoplastic polyurethane has typically a granular form after production. Therefore, preferably, at least component (A) is in the form of granules prior to the grinding. The granules may, for example, be spherical, cylindrical or ellipsoidal.

In that case, the method of producing a sinter powder (SP) comprising
the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c), comprises, in one embodiment, the step of
a) grinding the total amount, based on the total weight of the sinter powder (SP), of component (A),
wherein a first portion (BT1) of the total amount, based on the total weight of the sinter powder (SP), of component (B) and/or, optionally, a first portion (CT1) of the total amount, based on the total weight of the sinter powder (SP), of component (C) are mixed into component (A) prior to step a) to obtain a powder (P), and the remaining portion (BT2) of the total amount of component (B) and/or, optionally, the remaining portion (CT2) of the total amount of component (C) are mixed into the powder (P) after step a) to obtain the sinter powder (SP), wherein the first portion (BT1) accounts for 0% to 100% by weight of the total amount, based on the total weight of the sinter powder (SP), of component (B) and wherein the first portion (CT1) accounts for 0% to 100% by weight of the total amount, based on the total weight of the sinter powder (SP), of component (C), and wherein the remaining portion (BT2) accounts for (100-BT1)% by weight of the total amount, based on the total weight of the sinter powder (SP), of component (B) and the remaining portion (CT2) accounts for (100-CT1)% by weight of the total amount, based on the total weight of the sinter powder (SP), of component (C),
and wherein optionally
the total amount, based on the total weight of the sinter powder (SP), of component (D) and/or
the total amount, based on the total weight of the sinter powder (SP), of component (E) is mixed in before step a) or after step a).

Preferably, the at least one organic additive (C) is added to component (A) prior to the grinding operation. This can significantly increase the throughput during the grinding operation.

Methods of mixing are known as such to the person skilled in the art. Typically, component (B) and/or, optionally, (C), (D) and/or (E) are mixed into component (A) in dry form. However, it is also possible that the mixing is effected via compounding in an extruder, especially preferably in a twin-screw extruder. However, it is also possible that a combination of partial compounding and partial dry mixing is used.

In respect of the grinding in step a), the details and preferences described above are correspondingly applicable with regard to the grinding.

In a preferred embodiment, the at least one thermoplastic polyurethane (A) is annealed prior to step a) (in granular form) or after step a) (in powder form). Preferably, the at least one thermoplastic polyurethane (A) is annealed in granular form. This improves the printability of the powder.

For the purpose of the invention, the term “annealing” is understood to mean a thermal treatment of the at least one thermoplastic polyurethane (A).

Preferably, the at least one thermoplastic polyurethane (A) is heated at a temperature TT at most 100° C. below the melting temperature (TM(A) of the at least one thermoplastic polyurethane (A), more preferably at a temperature Tr at most 70° C. below the melting temperature (TM(A) of the at least one thermoplastic polyurethane (A), and especially preferably at a temperature Tr at most 40° C. below the melting temperature (TM(A)) of the at least one thermoplastic polyurethane (A).

In addition, the at least one thermoplastic polyurethane (A) is preferably heated at a temperature Tr at least 5° C. below the melting temperature (TM(A) of the at least one thermoplastic polyurethane (A), more preferably at a temperature Tr at least 10° C. below the melting temperature (TM(A) of the at least one thermoplastic polyurethane (A), and especially preferably at a temperature Tr at least 20° C. below the melting temperature (TM(A) of the at least one thermoplastic polyurethane (A).

The at least one thermoplastic polyurethane (A) is preferably heated for at least 3 hours, more preferably at least 10 hours and especially preferably at least 48 hours. Preferably, the at least one thermoplastic polyurethane (A) is heated for not more than 7 days. Heat treatment for longer than 7 days does not result in an improvement of properties and reduces the commercial value of the sinter powder (SP). The heating is preferably effected in a paddle drier (>4 t) under reduced pressure or under protective gas. The protective gas used is, for example, nitrogen.

The present invention therefore also further provides the sinter powder (SP) obtainable by the method of the invention.

### Component (A)

According to the invention, component (A) is at least one thermoplastic polyurethane.

In the context of the present invention, “at least one thermoplastic polyurethane” means either precisely one thermoplastic polyurethane (A) or a mixture of two or more thermoplastic polyurethanes (A).

It is also possible to use mixtures of the at least one thermoplastic polyurethane (A) with polymers, which are fully or at least partially miscible with the at least one thermoplastic polyurethane (A), as long as the at least one thermoplastic polyurethane (A) is comprised in the sinter powder (SP) at 58.5% to 99.95% by weight, preferably at 73.3% to 99.9% by weight, more preferably at 74.9% to 99.8% by weight, and most preferably at 75.4% to 99.75% by weight, based on the sum total of the percentages by weight of components (A), (B), (C), (D) and (E), preferably based on the total weight of the sinter powder (SP).

The at least one thermoplastic polyurethane (A) may be produced by any methods known to the person skilled in the art.

According to the invention, the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c).

Optionally, the at least one thermoplastic polyurethane (A) is also prepared in the presence of
(d) at least one catalyst,
(e) at least one additive and/or
(f) at least one reinforcer.

In the context of the present invention, the term “components (a), (b) and (c) each comprise not more than 15 mol-% of aromatic moieties, based on the total amount of the respective component (a), (b) and (c)” means that component (a) comprises not more than 15 mol-% of aromatic moieties, based on the total amount of component (a), that component (b) comprises not more than 15 mol-% of aromatic moieties, based on the total amount of component (b), and that component (c) comprises not more than 15 mol-% of aromatic moieties, based on the total amount of component (c).

In a preferred embodiment, components (a), (b) and (c) each comprise not more than 10 mol-%, preferably not more than 5 mol-%, and more preferably not more than 1 mol-%, of aromatic moieties, based on the total amount of the respective component (a), (b) and (c). In a particular preferred embodiment, components (a), (b) and (c) each do not comprise any aromatic moieties.

In the context of the present invention, the aromatic moieties which can be comprised in the component (a) are substituents comprising at least one cyclic ring comprising (4n+2) pi-electrons with n=0, 1, 2, . . . which can also comprise heteroatoms. These substituents are typically directly bond to at least one functional isocyanate group.

In the context of the present invention, the aromatic moieties which can be comprised in the component (b) are substituents comprising at least one cyclic ring comprising (4n+2) pi-electrons with n=0, 1, 2, . . . which can also comprise heteroatoms, as well as segments in the main chain of component (b) (which are also referred to as backbone by the person skilled in the art), comprising at least one cyclic ring comprising (4n+2) pi-electrons with n=0, 1, 2, . . . which can also comprise heteroatoms.

In the context of the present invention, the aromatic moieties which can be comprised in the component (c) are substituents comprising at least one cyclic ring comprising (4n+2) pi-electrons with n=0, 1, 2, . . . which can also comprise heteroatoms, as well as segments, comprising at least one cyclic ring comprising (4n+2) pi-electrons with n=0, 1, 2, . . . which can also comprise heteroatoms.

### Component (a)

Component (a) is at least one isocyanate.

In the context of the present invention, “at least one isocyanate” means either exactly one isocyanate or a mixture of two or more isocyanates.

The at least one isocyanate may be an aliphatic, cycloaliphatic, araliphatic and/or aromatic isocyanate.

Component (a) is preferably a diisocyanate, for example selected from the group consisting of trimethylene diisocyanate, tetramethylene diisocyanate, pentamethylene diisocyanate, hexamethylene 1,6-diisocyanate (HDI), heptamethylene diisocyanate, octamethylene diisocyanate, 2-methylpentamethylene 1,5-diisocyanate, 2-ethylbutylene 1,4-diisocyanate, pentamethylene 1,5-diisocyanate (PDI), butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane (1,4-HXDI), 1,3-bis(isocyanatomethyl)cyclohexane (1,3-HXDI), paraphenylene 2,4-diisocyanate (PPDI), tetramethylenexylene 2,4-diisocyanate (TMXDI), dicyclohexylmethane 4,4′-, 2,4′- and 2,2′-diisocyanate (H12 MDI), cyclohexane 1,4-diisocyanate, 1-methylcyclohexane 2,4- and 2,6-diisocyanate, diphenylmethane 2,2′-diisocyanate (2,2′-MDI), diphenylmethane 2,4′-diisocyanate (2,4′-MDI) and diphenylmethane 4,4′-diisocyanate (4,4′-MDI), naphthylene 1,5-diisocyanate (NDI), tolylene 2,4-diisocyanate (2,4-TDI) and tolylene 2,6-diisocyanate (2,6-TDI), diphenylmethane diisocyanate, 3,3′-dimethyldiphenyl diisocyanate, diphenylethane 1,2-diisocyanate and phenylene diisocyanate.

Component (a) is more preferably selected from the group consisting of 1,4-bis(isocyanatomethyl)cyclohexane (1,4-HXDI), tetramethylenexylene 2,4-diisocyanate (TMXDI), hexamethylene 1,6-diisocyanate (HDI), dicyclohexylmethane 2,2′-diisocyanate (H12 MDI), butylene 1,4-diisocyanate and 1-isocyanato-3,3,5-trimethyl-5-isocyanatomethylcyclohexane (isophorone diisocyanate, IPDI).

Component (a) is most preferably selected from the group consisting of hexamethylene 1,6-diisocyanate (HDI) and dicyclohexylmethane 2,2′-diisocyanate (H12 MDI).

According to the invention, component (a) comprises not more than 15 mol-% of aromatic moieties, based on the total amount of component (a). Preferably, component (a) comprises not more than 10 mol-%, more preferably not more than 5 mol-%, and most preferably not more than 1 mol-%, of aromatic moieties, based on the total amount of component (a). It is particularly preferred that component (a) does not comprise any aromatic moieties.

Prepolymers containing free isocyanate groups can be also used as component (a). The NCO content of these prepolymers is preferably between 10 mol-% and 25 mol-%, based on the initial content of employed NCO-groups. The prepolymers may offer the advantage that, owing to the preliminary reaction during the preparation of the prepolymers, a lower reaction time is needed for the preparation of the resulting thermoplastic polyurethanes (A).

According to the invention, the prepolymers comprise not more than 15 mol-% of aromatic moieties, based on the total amount of the prepolymers. Preferably, the prepolymers comprise not more than 10 mol-%, more preferably not more than 5 mol-%, and most preferably not more than 1 mol-%, of aromatic moieties, based on the total amount of the prepolymers. It is particularly preferred that the prepolymers do not comprise any aromatic moieties.

### Component (b)

Component (b) is at least one isocyanate-reactive compound.

In the context of the present invention “at least one isocyanate-reactive compound” is understood to mean either exactly one isocyanate-reactive compound or a mixture of two or more isocyanate-reactive compounds.

The at least one isocyanate-reactive compound (b) preferably has on statistical average at least 1.8 and at most 3.0 Zerewitinoff-active hydrogen atoms; this number is also referred to as the functionality of the isocyanate-reactive compound (b) and indicates the quantity of the isocyanate-reactive groups of the molecule calculated theoretically down to one molecule from a quantity of substance. The functionality is more preferably between 1.8 and 2.6, most preferably between 1.9 and 2.2 and especially preferably between 1.95 and 2.05.

The at least one isocyanate-reactive compound (b) preferably has a number average molecular weight MN between 500 g/mol and 8 000 g/mol determined according to DIN 55672-1:2016-03, preferably between 600 g/mol and 4 000 g/mol, more preferably between 700 g/mol and 3 000 g/mol, and particularly preferably between 900 g/mol and 2 500 g/mol.

The at least one isocyanate-reactive compound (b) preferably has at least one, and more preferably at least two reactive groups selected from the hydroxyl group, the amino group, the mercapto group or the carboxylic acid group. The preferred group is the hydroxyl group. These compounds are also referred to as polyols or polyhydroxy polyols. The at least one isocyanate-reactive compound (b) is preferably selected from the group consisting of polyester polyols, polyether polyols and polycarbonate diols, more preferably from the group consisting of polyether polyols and polyester polyols.

Preferred polyols are polyester polyols, preferably polyester diols. Polyester polyols selected from the following group are preferred: Polyesters based on adipic acid, succinic acid, pentanedioic acid, sebacic acid or mixtures thereof and 1,2-ethanediol and/or 1,4-butanediol, polyesters based on adipic acid, succinic acid, pentanedioic acid, sebacic acid or mixtures thereof and 1,4-butanediol and/or 1,6-hexanediol, polyesters based on caprolactone and neopentyl glycol and/or 1,4-butanediol (Poly-e-caprolactone), polyesters based on adipic acid, succinic acid, pentanedioic acid, sebacic acid or mixtures thereof and polytetramethylene glycol (PTHF) and/or polyesters based on caprolactone and polytetramethylene glycol (polytetrahydrofuran, PTHF), particularly preferably polyesters based on adipic acid and 1,4-butanediol and/or 1,6-hexanediol or polyesters based on adipic acid, succinic acid, pentanedioic acid, sebacic acid or mixtures thereof and polytetramethylene glycol (PTHF) or mixtures thereof.

Preferred polyols are further polyether polyols, preferably polyether diols, further preferred are those based on ethylene oxide, as well as propylene oxide, butylene oxide such as polypropylene oxide glycol or polybutylene oxide glycol, or polytetrahydrofuran (PTHF), or mixtures thereof. A particularly preferred polyether polyol is polytetrahydrofuran (PTHF).

In a preferred embodiment the polyol is a polytetrahydrofuran and has a number average molecular weight MN between 500 g/mol and 3 000 g/mol, determined according to DIN 55672-1:2016-03, more preferably with a number average molecular weight between 640 g/mol and 2 500 g/mol, even more preferably with a number average molecular weight MN between 900 g/mol and 1 700 g/mol, and most preferably between 950 g/mol and 1500 g/mol. They are commercially available under the tradename PolyTHF®

In one embodiment, as component (b) polyols are used, wherein the content of polyols, which are not polyether polyols, is ≤15 wt.-%, preferably ≤5 wt.-%, and more preferably ≤1 wt.-%, based on the total weight of the polyols. In a particularly preferred embodiment, only polyether polyols are used as component (b).

The present invention therefore further provides a sinter powder (SP), wherein as component (b) polyols are used, wherein the content of polyols, which are not polyether polyols, is ≤15 wt.-%, preferably ≤5 wt.-%, and more preferably ≤1 wt.-%, based on the total weight of the polyols.

In another embodiment, as component (b) polyols are used, wherein the content of polyols, which are not polyester polyols, is ≤15 wt.-%, preferably ≤5 wt.-%, and more preferably ≤1 wt.-%, based on the total weight of the polyols. In a particularly preferred embodiment, only polyester polyols are used as component (b).

According to the invention, component (b) comprises not more than 15 mol-% of aromatic moieties, based on the total amount of component (b). Preferably, component (b) comprises not more than 10 mol-%, more preferably not more than 5 mol-%, and most preferably not more than 1 mol-%, of aromatic moieties, based on the total amount of component (b). It is particularly preferred that component (b) does not comprise any aromatic moieties.

### Component (c)

Component (c) is at least one chain extender, preferably having a number average molecular weight MN in the range from 50 to 499 g/mol, more preferably in the range from 60 to 130 g/mol.

In the context of the present invention, “at least one chain extender” means either exactly one chain extender or a mixture of two or more chain extenders. Preferably, exactly one chain extender is used as component (c).

Component (c) may be aliphatic, araliphatic, aromatic and/or cycloaliphatic.

Preferably, component (c) has two isocyanate-reactive groups.

Preferred chain extenders are therefore diamines and/or alkanediols, preferably alkanediols.

In a preferred embodiment, the at least one chain extender (c) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and deca alkylene glycol dipropylene glycol, 1,4-cyclohexanediol, 1,4-dimethanol cyclohexane, neopentyl glycol and hydroquinone bis (beta-hydroxyethyl) ether (HQEE).

Preferably, the at least one chain extender (c) is selected from the group consisting of 1,2-ethylene glycol, 1,3-propanediol, 1,4-butanediol, 1,6-hexanediol, di-, tri-, tetra-, penta-, hexa-, hepta-, okta-, nona- and deca alkylene glycol.

Particularly preferably, the at least one chain extender (c) is selected from the group consisting of 1,2-ethylene glycol, 1,3-propanediol, 1,4-butanediol and 1,6-hexanediol.

According to the invention, component (c) comprises not more than 15 mol-% of aromatic moieties, based on the total amount of component (c). Preferably, component (c) comprises not more than 10 mol-%, more preferably not more than 5 mol-%, and most preferably not more than 1 mol-%, of aromatic moieties, based on the total amount of component (c). It is particularly preferred that component (c) does not comprise any aromatic moieties.

According to the invention, the content of chain-extenders in component (c), which are not alkane diols, is ≤15 wt.-%, preferably ≤5 wt.-% and more preferably ≤1 wt.-%, based on the total weight of polyols in component (c). In a particularly preferred embodiment, only alkane diols are used as component (c).

### Component (d)

Component (d) is at least one catalyst.

In the context of the present invention “at least one catalyst (d)” means either exactly one catalyst (d) or a mixture of two or more catalysts (d).

Catalysts as such are known to those skilled in the art. In the context of the present invention, preference is given to using catalysts that accelerate the reaction between the NCO groups of the at least one isocyanate (component (a)) and the hydroxyl groups of the isocyanate-reactive compound (component (b)) and, if used, the chain extender (component (c)).

Suitable catalysts are, for example, tertiary amines, especially triethylamine, dimethylcyclohexylamine, N-methylmorpholine, N,N′-dimethylpiperazine, 2-(dimethylaminoethoxy)ethanol and diazabicyclo[2.2.2]octane.

In the context of the present invention, preference is given to using organic metal compounds, for example, titanic esters, iron compounds, tin compounds and bismuth salts.

Preferred tin compounds are dialkyltin salts of aliphatic carboxylic acids, for example, tin diacetate, tin dioctoate and tin dilaurate. Preferably, tin dioctoate is used.

Preferred bismuth salts are salts, wherein the bismuth is present in the oxidation states 2 or 3, in particular 3, with preference being given to salts of carboxylic acids, preferably carboxylic acids having from 6 to 14 carbon atoms, particularly preferably from 8 to 12 carbon atoms.

Very preferred bismuth salts are bismuth(III) neodecanoate, bismuth 2-ethylhexanoate and bismuth octanoate.

The at least one catalyst (d) is preferably used in an amount of from 0.50 ppm to 1000 ppm based on the total weight of components (a), (b), (c) and (d), and optionally (e) and (f), more preferably 0.75 ppm to 500 ppm, and most preferably 0.99 ppm to 201 ppm.

Preference is given to using tin catalysts, in particular tin dioctoate.

A very preferred catalyst is SDO (tin (II) 2-ethylhexanoate).

### Component (e)

Component (e) is at least one additive.

In the context of the present invention, “at least one additive (e)” means either exactly one additive (e) or a mixture of two or more additives (e).

The at least one additive (e) may be either the same as the at least one further additive (D) described further down or different than the at least one further additive (D) described further down. It is preferably different than the at least one further additive (D) described further down.

However, the at least one additive (e) and the at least one further additive (D) differ in the manner of their addition. While the at least one additive (e) is preferably added to the reaction mixture during the synthesis of component (A) and hence incorporated into the TPU polymer or added to component (A) directly after the synthesis of component (A), the at least one further additive (D) is only added directly before, during or after the production of the sinter powder (SP).

Preferably, the at least one additive (e) is selected from the group consisting of surface-active substances, flame retardants, nucleating agents, oxidation stabilizers, lubricating and demolding aids, waxes, dyes and pigments, stabilizers against hydrolysis, light, heat or discoloration, and plasticizers.

Examples of suitable stabilizers are, for example, primary and secondary antioxidants, sterically hindered phenols, hindered amine light stabilizers (HALS), UV absorbers, hydrolysis inhibitors, quenchers and flame retardants. Examples of commercially available stabilizers are found in Plastics Additives Handbook, 5th edition, H. Zweifel, ed., Hanser Publishers, Munich, 2001 ([1]), pp. 98-136. An example of a commercially available stabilizer is Irganox® from BASF SE.

Suitable UV absorbers preferably have a number average molecular weight MN of at least 200 g/mol, more preferably of at least 300 g/mol. In addition, suitable UV absorbers preferably have a number average molecular weight MN of at most 10 000 g/mol, more preferably of at most 5 000 g/mol and most preferably of at most 3 500 g/mol.

Particularly suitable UV absorbers are UV absorbers selected from the group consisting of cinnamates, oxanilides and benzotriazoles, particular preference being given to benzotriazoles. Examples of particularly suitable benzotriazoles are Tinuvin® 213, Tinuvin® 234, Tinuvin® 312, Tinuvin® 571, and Tinuvin® 384 and Eversorb® 82.

Typically, the UV absorbers are added in amounts of 0.01% to 5% by weight, based on the mass of components (a), (b), (c) and (e), preferably in amounts of 0.1% to 2.0% by weight, especially in amounts of 0.2% to 0.7% by weight.

Particularly preferred hindered amine light stabilizers (HALS) are bis(1,2,2,6,6-pentamethylpiperidyl) sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). Especially preferred is the condensation product of 1-hydroxyethyl-2,2,6,6-tetramethyl-4-hydroxypiperidine and succinic acid (Tinuvin® 622). Examples of commercially available HALS stabilizers can be found in Plastics Additive Handbook, 5th edition, H. Zweifel, Hanser Publishers, Munich, 2001, pp. 123-136.

Typically, the HALS are added in amounts of 0.01% to 5% by weight, based on the mass of components (a), (b), (c) and (e), preferably in amounts of 0.1% to 2.0% by weight, especially in amounts of 0.2% to 0.7% by weight.

A particularly preferred stabilization comprises a mixture of a phenolic stabilizer, a benzotriazole and a HALS compound in the above-described preferred amounts.

### Component (f)

Component (f) is at least one reinforcer.

In the context of the present invention, “at least one reinforcer (f)” means either exactly one reinforcer (f) or a mixture of two or more reinforcers (f).

The at least one reinforcer (f) may be either the same as the at least one reinforcer (E) described further down or different than the at least one reinforcer (E) described further down.

For example, the at least one reinforcer (f) is selected from the group consisting of carbon nanotubes, carbon fibers, boron fibers, glass fibers, glass beads, silica fibers, ceramic fibers, basalt fibers, aluminum silicates, talc, aramid fibers and polyester fibers. Preferably, talc is used.

The at least one reinforcer (f) may be added to the reaction mixture in the course of production of component (A), in which case it may be added in dry form or as a masterbatch.

However, it is also possible that no reinforcer (f) is added in the course of production of component (A) to the reaction mixture. In this case, it is possible that at least one reinforcer (E) described further down is added to components (A) and (B), and optionally (C) and (D), in the course of production of the sinter powder (SP).

It is of course also possible in the course of production of component (A) to add at least one reinforcer (f) to the reaction mixture and then to add at least one reinforcer (E) to components (A) and (B), and optionally (C) and (D), in the course of production of the sinter powder (SP).

### Production of Component (A)

The at least one thermoplastic polymer (A) may be produced in a discontinuous process or a continuous process. For example, the production of the thermoplastic polyurethane (A) is carried out with a single screw or a twin-screw reaction extruder or the belt line process or the batch cast process.

Preferably, the production of the thermoplastic polyurethane (A) is carried out in a continuous process with a twin-screw reaction extruder, wherein the components (a), (b), (c) and, optionally, components (d), (e) and/or (f) are mixed together successively or simultaneously (“one-shot” process), preferably successively, with the polymerization reaction starting immediately. Alternatively, a prepolymer process can be used.

In the prepolymer process the above-described isocyanates (component (a)) are reacted in excess, at temperatures of 30° C. to 200° C., preferably at 80° C. to 180° C., with the component (b). The resulting NCO-terminated polymer is then added into the reaction extruder.

In the extruder method, components (a), (b) and (c), and, optionally, also components (d), (e) and/or (f), are introduced into the extruder individually or in the form of a mixture and reacted, preferably at temperatures of 100° C. to 280° C., more preferably at temperatures of 140° C. to 250° C. The polyurethane obtained is extruded, cooled and, preferably, granulated.

In one embodiment, the component (f) is added during synthesis of the polyisocyanate polyaddition product, preferably the thermoplastic polyurethane (A). In another preferred embodiment the component (f) is added to the polyisocyanate polyaddition product, preferably the thermoplastic polyurethane (A), after its synthesis, preferably in an extruder.

In order to adjust the hardness and melt flow index of the at least one thermoplastic polyurethane (TPU), the molar ratios of the quantities of the components (b) and (c) can be varied, whereby the hardness and melt viscosity increase with increasing content of component (c), while the melt flow index decreases.

In order to prepare the at least one thermoplastic polyurethane (A), the equivalent ratio of NCO groups of component (a) to the sum of hydroxyl groups of components (b) and (c) is preferably 0.95 to 1.10:1, more preferably 0.98 to 1.08:1 and in particular 0.99 to 1.05:1.

For the production of the thermoplastic polyurethanes (A) according to the invention, the mole ratio of component (b) to component (c), is preferably 1:1.0 to 1:8.0, more preferably 1:1.1 to 1:7.0 and more preferably 1:1.2 to 1:6.5.

### Component (B)

According to the invention, component (B) is at least one flow agent.

In the context of the present invention, “at least one flow agent (B)” means either exactly one flow agent (B) or a mixture of two or more flow agents (B).

Flow agents as such are known to those skilled in the art. In the context of the present invention, the at least one flow agent (B) is preferably an inorganic compound.

The at least one flow agent (B) is selected, for example, from the group consisting of silicon dioxide (silica), silicates, silicas, metal oxides and hydroxides, minerals, borates, phosphates, sulfates and carbonates.

Examples of suitable silicon dioxides (silica compounds) are hydrated silicon dioxides, vitreous silicon dioxides and pyrogenic silicon dioxides.

Examples of suitable silicates are aluminosilicates, alkali metal silicates, alkaline earth metal silicates, alkali metal aluminosilicates, alkaline earth metal aluminosilicates, calcium silicates and magnesium silicates.

Examples of suitable silicas are hydrophobic or hydrophilic fumed silicas and/or not fumed silicas.

Examples of suitable metal oxides and/or hydroxides include alumina, aluminum hydroxide, titania, magnesium hydroxide, magnesium oxide, calcium oxide, zinc oxide, antimony oxide and vitreous oxides.

Examples of suitable minerals are talc, mica, kaolin and attapulgite. Preferred are talc, mica or kaolin.

Examples of suitable borates and phosphates are vitreous borates and vitreous phosphates.

Examples of suitable sulfates are magnesium sulfate, calcium sulfate and barium sulfate. Examples of suitable carbonates are magnesium carbonate, calcium carbonate and barium carbonate.

Preferably, the at least one flow agent (B) is selected from the group consisting of hydrophobic fumed silicas, talc, kaolin, magnesium sulfate, calcium sulfate, barium sulfate, magnesium carbonate, calcium carbonate and barium carbonate.

The at least one flow agent (B) typically comprises particles. These particles have, for example, a size (D90) of ≤10 μm, preferably of ≤2 μm.

In the context of the present invention, the “D90” is to be understood to mean the particle size at which 90% by volume of the particles based on the total volume of the particles are smaller than or equal to the D90 and 10% by volume of the particles based on the total volume of the particles are larger than the D90.

The D90 is determined in the context of the present invention by means of laser diffraction to ISO 13320: 2020-01 (Horiba LA-960, Retsch Technology, Germany), preceded by dry dispersion of the sinter powder (SP) or the at least one flow agent (B) at 1 bar. The evaluation is effected with the aid of the Fraunhofer method.

The sinter powder (SP) preferably comprises at least 0.05% by weight, more preferably at least 0.1% by weight, most preferably at least 0.2% by weight, and especially preferably at least 0.25% by weight of component (B), based on the sum total of the percentages by weight of components (A), (B), optionally (C), optionally (D) and optionally (E), preferably based on the total weight of the sinter powder (SP).

In addition, the sinter powder (SP) preferably comprises at most 1.5% by weight, more preferably at most 1.2% by weight, most preferably at most 1.1% by weight, and especially preferably at most 1.0% by weight of component (B), based on the sum total of the percentages by weight of components (A), (B), optionally (C), optionally (D) and optionally (E), preferably based on the total weight of the sinter powder (SP).

### Component (C)

According to the invention, component (C) is at least one organic additive.

In the context of the present invention, “at least one organic additive” means either exactly one organic additive or a mixture of two or more organic additives.

For example, the at least one organic additive (C) is selected from the group consisting of polyethylene waxes, polypropylene waxes, maleic acid- and/or maleic anhydride-grafted polypropylene waxes, amide waxes, fatty acid esters and glycerol fatty acid esters.

Component (C) is preferably at least one organic additive selected from maleic acid- and/or maleic anhydride-grafted polypropylene waxes and amide waxes. Component (C) is more preferably an N,N′-alkylene fatty acid diamide. Component (C) is most preferably N,N′-ethylenedi(stearamide).

Suitable organic additives are obtainable, for example, from Clariant or Baerlocher. One example of a suitable maleic acid- and/or maleic anhydride-grafted polypropylene wax is Licocene PP MA 6452 TP from Clariant.

In the context of the present invention, “maleic acid- and/or maleic anhydride-grafted” means that the polypropylene waxes are branched, with polypropylene present in their main chain and maleic acid and/or maleic anhydride in their branched chain.

In a preferred embodiment of the present invention, the at least one organic additive (C) is selected such that the dropping point D_{P} of the at least one organic additive (C) satisfies the following condition (formula I):

$$( {T}_{M ( A )} - 25 ° C . ) \leq {D}_{p} < ( {T}_{M ( A )} + 25 ° C . ) \qquad ( I )$$

where D_{P} is the dropping point of the at least one organic additive (C) and T_{M(A)}is the melting temperature of the at least one thermoplastic polyurethane (A).

In a more preferred embodiment of the present invention, the at least one organic additive (C) is selected such that the dropping point D_{P} of the at least one organic additive (C) satisfies the following condition (formula II):

$$( {T}_{M ( A )} - 20 ° C . ) \leq {D}_{P} < ( {T}_{M ( A )} + 20 ° C . ) . \qquad ( II )$$

In an especially preferred embodiment of the present invention, the at least one organic additive (C) is selected such that the dropping point D_{P} of the at least one organic additive (C) satisfies the following condition (formula III):

$$( {T}_{M ( A )} - 15 ° C . ) \leq {D}_{P} < ( {T}_{M ( A )} + 15 ° C . ) . \qquad ( III )$$

Especially preferably, the at least one organic additive (C) is selected such that the dropping point D_{P} of the at least one organic additive (C) satisfies the following condition (formula IV):

$${T}_{M ( A ) , Onset} \leq {D}_{P} < {T}_{M ( A ) , Endset} , \qquad ( IV )$$

where T_{M(A),Onset} denotes the start of the melt peak of the at least one thermoplastic polyurethane (A) and T_{M(A),Endset} the end of the melt peak of the at least one thermoplastic polyurethane (A).

If the dropping point D_{P} of the at least one organic additive (C) cannot be determined, the at least one organic additive (C), in a preferred embodiment of the present invention, is selected such that the melting temperature T_{M(C)} of the at least one organic additive (C) satisfies the following condition (formula V):

$$( {T}_{M ( A )} - 25 ° C . ) \leq {T}_{M ( C )} < ( {T}_{M ( A )} + 25 ° C . ) , \qquad ( V )$$

where T_{M(C)} is the melting temperature of the at least one organic additive (C) and T_{M(A)} is the melting temperature of the at least one thermoplastic polyurethane (A).

In a more preferred embodiment of the present invention, the at least one organic additive (C) is selected such that the melting temperature T_{M(C)} of the at least one organic additive (C) satisfies the following condition (formula VI):

$$( {T}_{M ( A )} - 20 ° C . ) \leq {T}_{M ( C )} < ( {T}_{M ( A )} + 20 ° C . ) . \qquad ( VI )$$

In an especially preferred embodiment of the present invention, the at least one organic additive (C) is selected such that the melting temperature T_{M(C)} of the at least one organic additive (C) satisfies the following condition (formula VII):

$$( {T}_{M ( A )} - 15 ° C . ) \leq {T}_{M ( C )} < ( {T}_{M ( A )} + 15 ° C . ) . \qquad ( VII )$$

Especially preferably, the at least one organic additive (C) is then selected such that the melting temperature T_{M(C)} of the at least one organic additive (C) satisfies the following condition (formula VIII):

$${T}_{M ( A ) , Onset} \leq {T}_{M ( C )} < {T}_{M ( A ) , Endset} , \qquad ( VIII )$$

where T_{M(A),Onset} denotes the start of the melt peak of the at least one thermoplastic polyurethane (A) and T_{M(A),Endset} the end of the melt peak of the at least one thermoplastic polyurethane (A).

In addition, the at least one organic additive (C) is preferably selected such that the total interfacial energy Y's of the sinter powder (SP) is ≤25 mN·m⁻¹, preferably ≤20 mN·m⁻¹, and especially preferably ≤15 mN·m⁻¹. The disperse component of the interfacial energy γ_{S}^{D} should preferably be ≤20 mN·m⁻¹, preferably ≤15 mN·m⁻¹, and especially preferably ≤13 mN·m⁻¹, and the polar component of the interfacial energy Y's should preferably be ≤5 mN·m⁻¹, preferably ≤4 mN·m⁻¹, and especially preferably ≤3 mN·m⁻¹.

In the context of the present invention, interfacial energy is calculated with the aid of the Owens-Wendt model (Owens, D. K.; Wendt, R. C.; Jour. of Applied Polymer Science, 13, 1741, (1969)).

For this purpose, the pulverulent samples are applied to a self-produced adhesive film (Acronal V215 on PET film). Excess material is removed with an airgun. 8 to 10 drops of test liquids (ethylene glycol, formamide, water) are each applied to the powder layers with a droplet volume of about 1.5 μL. The contact angle θ is determined by droplet contour analysis directly after the first contact with the surface (5 s after the separation of the droplet). The measurement is conducted at 23° C. The analysis unit used is a Drop Shape Analyzer DSA100 (Krüss GmbH, Germany).

FIG. 2 shows the contact angle θ, the interfacial energy of the test liquid γ_{L}, the interfacial energy of the sinter powder (SP) γ_{S} and the interfacial energy γ_{SL} between test liquid and sinter powder (SP). The contact angle is measured by applying the test liquid (I) to the sample (II).

With the aid of the Owens-Wendt equation (formula IX) and the measured contact angle θ, it is possible by means of linear regression to ascertain the interfacial energy of the powder γ_{S} with the polar component γ_{S}^{P} and the disperse component γ_{S}^{P}:

$$\frac{{γ}_{L} ( 1 + cos θ )}{2 {( {γ}_{L}^{D} )}^{1 / 2}} = {( {γ}_{S}^{P} )}^{1 / 2} \frac{{( {γ}_{L}^{P} )}^{1 / 2}}{{( {γ}_{L}^{D} )}^{1 / 2}} + {( {γ}_{S}^{D} )}^{1 / 2} \qquad ( IX )$$

The following relationships should be noted here (formula X and formula XI):

$${γ}_{L} = {γ}_{L}^{D} + {γ}_{L}^{P} \qquad ( X )$$

$${γ}_{S} = {γ}_{S}^{D} + {γ}_{S}^{P} \qquad ( XI )$$

### Meaning of the Variables:

θ contact angle
γ_{L} interfacial energy of the test liquid
γ_{L}^{D} disperse component of the interfacial energy of the test liquid
γ_{L}^{P} polar component of the interfacial energy of the test liquid
γ_{S} interfacial energy of the sinter powder (SP)
γ_{S}^{D} disperse component of the interfacial energy of the sinter powder (SP)
γ_{S}^{P} polar component of the interfacial energy of the sinter powder (SP)

The sinter powder (SP) preferably comprises at least 0.1% by weight, more preferably at least 0.3% by weight and especially preferably at least 0.5% by weight of component (C), based on the sum total of the percentages by weight of components (A), (B), (C), optionally (D) and optionally (E), preferably based on the total weight of the sinter powder (SP).

In addition, the sinter powder (SP) preferably comprises at most 5.0% by weight, more preferably at most 3.0% by weight, most preferably at most 1.5% by weight, and especially preferably at most 1.1% by weight of component (C), based on the sum total of the percentages by weight of components (A), (B), (C), optionally (D) and optionally (E), preferably based on the total weight of the sinter powder (SP).

### Component (D)

Component (D) is at least one further additive.

In the context of the present invention, “at least one further additive” means either exactly one further additive or a mixture of two or more further additives.

Additives as such are known to those skilled in the art. For example, the at least one further additive is selected from the group consisting of antinucleating agents, stabilizers, conductive additives, end group functionalizers, dyes, antioxidants (preferably sterically hindered phenols), flame retardants and color pigments.

An example of a suitable antinucleating agent is lithium chloride. Suitable stabilizers are, for example, phenols, phosphites, metal soaps and copper stabilizers. Suitable conductive additives are carbon fibers, metals, stainless steel fibers, carbon nanotubes and carbon black. Suitable end group functionalizers are, for example, terephthalic acid, adipic acid and propionic acid. Suitable dyes and color pigments are, for example, carbon black and iron chromium oxides. An example of a suitable antioxidant is Irganox® 245 from BASF SE.

Flame retardants in the sense of this invention are inorganic, organic and/or metal organic compounds. The flame retardants can be halogenated, e.g. brominated or chlorinated, compounds, phosphorous-based e.g. organophosphorus compounds or red phosphor, melamine-based compounds, metal oxide and/or hydroxide compounds, silicon-based compounds or phosphate and/or phosphinate-based or mixtures thereof. Preferably non-halogenated flame retardants are used.

Examples for metal oxides and hydroxides are antimony trioxide, aluminum trihydroxide (ATH) and magnesium dihydroxide (MDH).

Examples for melamine-based compounds are pure melamine, melamine derivatives, i.e. salts with organic or inorganic acids such as boric acid, cyanuric acid, phosphoric acid or pyro/poly-phosphoric acid, and melamine homologues such as melam, melem and melon.

Examples for phosphate or phosphinate-based are tiphenylphosphate, tricresylphosphate, triphenylphosphate, cresyldiphenyl phosphate, tri(isopropylphenyl)phosphate, bisarylphosphates such as resorcinol bis diphenylphosphate bisphenol A bis-diphenylphosphate (BDP), alkyl phosphonates, comprising n-alkyl, dimeric, oligomeric and cyclic alkyl phosphonates, ammonium polyphosphate, and metal diethyl phosphinate.

If the sinter powder (SP) comprises component (D), it preferably comprises at least 0.1% by weight of component (D), more preferably at least 0.2% by weight of component (D), based on the sum total of the percentages by weight of components (A), (B), optionally (C), (D) and optionally (E), preferably based on the total weight of the sinter powder (SP).

If the sinter powder (SP) comprises component (D), it preferably also comprises at most 5% by weight of component (D), more preferably at most 2.5% by weight of component (D), based on the sum total of the percentages by weight of components (A), (B), optionally (C), (D) and optionally (E), preferably based on the total weight of the sinter powder (SP).

### Component (E)

According to the invention, component (E) is at least one reinforcer.

In the context of the present invention, “at least one reinforcer” means either exactly one reinforcer or a mixture of two or more reinforcers.

In the context of the present invention, a reinforcer is understood to mean a material that improves the mechanical properties of three-dimensional shaped articles produced by the method of the invention compared to three-dimensional shaped articles that do not comprise the reinforcer.

Reinforcers as such are known to those skilled in the art. Component (E) may, for example, be in spherical form, in platelet form or in fibrous form.

Preferably, the at least one reinforcer is in spherical form or in platelet form.

In the context of the present invention, “in platelet form” is understood to mean that the particles of the at least one reinforcer have a ratio of diameter to thickness in the range from 4:1 to 10:1, determined by means of microscopy with image evaluation after ashing.

Suitable reinforcers are known to the person skilled in the art and are selected, for example, from the group consisting of carbon nanotubes, glass beads and aluminum silicates.

The at least one reinforcer is preferably selected from the group consisting of glass beads and aluminum silicates. These reinforcers may additionally have been epoxy-functionalized.

Suitable aluminum silicates are known as such to the person skilled in the art. Aluminum silicates refer to compounds comprising Al₂O₃ and SiO₂. In structural terms, a common factor among the aluminum silicates is that the silicon atoms are tetrahedrally coordinated by oxygen atoms and the aluminum atoms are octahedrally coordinated by oxygen atoms. Aluminum silicates may additionally comprise further elements.

Preferred aluminum silicates are sheet silicates. Particularly preferred aluminum silicates are calcined aluminum silicates, especially preferably calcined sheet silicates. The aluminum silicate may additionally have been epoxy-functionalized.

If the at least one reinforcer is an aluminum silicate, the aluminum silicate may be used in any form. For example, it can be used in the form of pure aluminum silicate, but it is likewise possible that the aluminum silicate is used in mineral form. Preferably, the aluminum silicate is used in mineral form. Suitable aluminum silicates are, for example, feldspars, zeolites, sodalite, sillimanite, andalusite and kaolin. Kaolin is a preferred aluminum silicate. Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

It is clear to a person skilled in the art that component (E) is different than component (B). Component (E) typically has a higher particle diameter than component (B), meaning that it has, for example, a size (D90)>10 μm.

If the sinter powder comprises component (E), it preferably comprises at least 5% by weight of component (E), more preferably at least 10% by weight of component (E), based on the sum total of the percentages by weight of components (A), (B) and (E), and optionally (C) and (D), preferably based on the total weight of the sinter powder (SP).

If the sinter powder comprises component (E), it also preferably comprises at most 30% by weight of component (E), more preferably at most 20% by weight of component (E), based on the sum total of the percentages by weight of components (A), (B) and (E), and optionally (C) and (D), preferably based on the total weight of the sinter powder (SP).

### Sintering Method

The present invention further provides a method of producing three-dimensional shaped articles, comprising the steps of:
i) providing a layer of the sinter powder (SP),
ii) exposing or heating the layer of the sinter powder (SP) provided in step i).

In step ii), the layer of the sinter powder (SP) provided in step i) is exposed or heated.

On exposure or heating, at least some of the layer of the sinter powder (SP) melts. The molten sinter powder (SP) coalesces and forms a homogeneous melt. After the exposure, the molten part of the layer of the sinter powder (SP) cools down again and the homogeneous melt solidifies again.

Suitable methods of exposure include any methods known to those skilled in the art. Preferably, the exposure in step ii) is effected with a radiation source. The radiation source is preferably selected from the group consisting of infrared sources and lasers. Especially preferred infrared sources are near-infrared sources.

The present invention therefore also provides a method in which the exposing in step ii) is effected with a radiation source selected from the group consisting of lasers and infrared sources.

Suitable lasers are known to those skilled in the art and are for example fiber lasers, Nd:YAG lasers (neodymium-doped yttrium aluminum garnet lasers) or carbon dioxide lasers. The carbon dioxide laser typically has a wavelength of 10.6 μm.

If the radiation source used in the exposing in step ii) is a laser, the layer of the sinter powder (SP) provided in step i) is typically exposed locally and briefly to the laser beam. This selectively melts just the parts of the sinter powder (SP) that have been exposed to the laser beam. If a laser is used in step ii), the method of the invention is also referred to as selective laser sintering. Selective laser sintering is known per se to those skilled in the art.

If the radiation source used in the exposing in step ii) is an infrared source, especially a near-infrared source, the wavelength at which the radiation source radiates is typically in the range from 780 nm to 1000 μm, preferably in the range from 780 nm to 50 μm and especially in the range from 780 nm to 2.5 μm.

In the exposing in step ii), in that case, the entire layer of the sinter powder (SP) is typically exposed. In order that only the desired regions of the sinter powder (SP) melt in the exposing, a fusing agent comprising at least on radiation absorber (sometimes also referred to as an ink) is typically applied to the regions that are to melt.

The method of producing the three-dimensional shaped article in that case preferably comprises, between step i) and step ii), a step i-1) of applying at least one fusing agent comprising at least on radiation absorber to at least part of the layer of the sinter powder (SP) provided in step i).

The present invention therefore also further provides a method of producing a three-dimensional shaped article, comprising the steps of:
i) providing a layer of a sinter powder (SP) comprising the following components:
   (A) 58.5% to 99.95% by weight, based on the sum total of the percentages by weight of (A), (B), (C), (D) and (E), of at least one thermoplastic polyurethane,
   (B) 0.05% to 1.5% by weight, based on the sum total of the percentages by weight of (A), (B), (C), (D) and (E), of at least one flow agent,
   (C) 0% to 5% by weight, based on the sum total of the percentages by weight of (A), (B), (C), (D) and (E), of at least one organic additive,
   (D) 0% to 5% by weight, based on the sum total of the percentages by weight of (A), (B), (C), (D) and (E), of at least one further additive, and
   (E) 0% to 30% by weight, based on the sum total of the percentages by weight of (A), (B), (C), (D) and (E), of at least one reinforcer,
   wherein the at least one thermoplastic polyurethane (A) is prepared by reacting at least the following components
   (a) at least one isocyanate,
   (b) at least one isocyanate-reactive compound, and
   (c) at least one chain extender,
   wherein components (a), (b) and (c) each comprise not more than 15 mol-% of aromatic moieties, based on the total amount of the respective component (a), (b) and (c),
i-1) applying at least one fusing agent comprising at least one radiation absorber to at least part of the layer of the sinter powder (SP) provided in step i),
ii) exposing the layer of the sinter powder (SP) provided in step i).

Suitable radiation absorbers are all radiation absorbers known to those skilled in the art, especially IR-absorbers known to those skilled in the art for high-speed sintering and multi-jet fusion processes.

Fusing agents are typically inks comprising at least one absorber that absorbs IR radiation, preferably NIR radiation (near-infrared radiation). In the exposing of the layer of the sinter powder (SP) in step ii), the absorption of the IR radiation, preferably the NIR radiation, by the IR absorber present in the IR-absorbing inks results in selective heating of the part of the layer of the sinter powder (SP) to which the IR-absorbing ink has been applied.

The IR-absorbing ink may, as well as the at least one absorber, comprise a carrier liquid. Suitable carrier liquids are known to those skilled in the art, and are, for example, oils or water.

The at least one absorber may be dissolved or dispersed in the carrier liquid.

If the exposure in step ii) is effected with a radiation source selected from infrared sources and if step i-1) is conducted, the method of the invention is also referred to as high-speed sintering (HSS) or multi-jet fusion (MJF) method. These methods are known per se to those skilled in the art. In the multi-jet fusion (MJF) method, a non-absorbing ink, a “detailing agent”, is typically also used.

After step ii), the layer of the sinter powder (SP) is typically lowered by the layer thickness of the layer of the sinter powder (SP) provided in step i) and a further layer of the sinter powder (SP) is applied. This is subsequently exposed or heated again in step ii).

This firstly bonds the upper layer of the sinter powder (SP) to the lower layer of the sinter powder (SP); in addition, the particles of the sinter powder (SP) within the upper layer are bonded to one another by fusion.

In the method of the invention, steps i) and ii) and optionally i1) can thus be repeated.

By repeating the lowering of the powder bed, the applying of the sinter powder (SP) and the exposure or heating and hence the melting of the sinter powder (SP), three-dimensional (3D) printed articles are produced. It is possible to produce three-dimensional shaped articles that also have cavities, for example. No additional support material is necessary since the unmolten sinter powder (SP) itself acts as a support material.

The present invention therefore also further provides a three-dimensional shaped article obtained via a sintering method using a sinter powder (SP) of the invention.

The sinter powder (SP) of the invention is of particularly good suitability for use in a sintering method.

The present invention therefore also provides for the use of a sinter powder (SP) comprising the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c),
in a three-dimensional (3D) printing process, preferably in a sintering process, more preferably in a selective laser sintering (SLS) process or in a multi-jet fusion (MJF) process.

However, it is also possible to use the sinter powder (SP) of the present invention for the production of three-dimensional shaped articles not only in the selective laser sintering (SLS) method or the multi-jet fusion (MJF) method but also in other powder-based 3D printing methods.

The present invention further provides for the use of at least one thermoplastic polyurethane (A), wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c),
in a three-dimensional (3D) printing process for producing a three-dimensional shaped article to improve the energy return of the three-dimensional shaped article.

### Three-Dimensional Shaped Article

The method of the invention affords a three-dimensional shaped article. The three-dimensional shaped article can be removed from the powder bed after cooling. Any adhering particles of the sinter powder that have not been melted can be mechanically removed from the surface by known methods. Methods for surface treatment of the three-dimensional shaped article include, for example, vibratory grinding or barrel polishing, and also sandblasting, glass bead blasting or microbead blasting.

It is also possible to subject the three-dimensional shaped articles obtained to further processing or, for example, to treat the surfaces.

The present invention therefore further provides a three-dimensional shaped article obtained by the method of the invention.

The resultant three-dimensional shaped article preferably has a tensile strength of ≥4 MPa, more preferably of ≥5 MPa, most preferably of ≥6 MPa, and especially preferably of ≥7 MPa. The resultant three-dimensional shaped article preferably has an elongation at break of ≥50%, more preferably of ≥150%, and most preferably of ≥200%. The resultant three-dimensional shaped article also preferably has an E-modulus in the range of 92 to 300 MPa, more preferably in the range of 95 to 280 MPa, and most preferably in the range of 100 to 270 MPa.

In the context of the present invention, tensile strength, elongation at break and E-modulus are determined according to ISO 527-1: 2019-09, on a 3D-printed type 1A tensile bar.

Furthermore, the resultant three-dimensional shaped article preferably has a Shore A hardness of >85, more preferably of ≥87, and most preferably ≥89, determined according to ISO 7619-1, 3s or ISO 48-4.

Moreover, the resultant three-dimensional shaped article preferably has a density of ≥ 0.80 g/cm³, more preferably of ≥0.85 g/cm³, most preferably of ≥0.90 g/cm³, and especially preferably of ≥0.95 g/cm³, determined according to DIN EN ISO 1183-1.

The energy return of the obtained three-dimensional shaped article is preferably ≥55%, more preferably >60%, most preferably ≥62%, and especially preferably ≥65%.

In the context of the present invention, the energy return is determined according to DIN 53512 on a 3D-printed full disk with ratios as defined in the norm.

The three-dimensional shaped article can be 3D-printed either via selective laser sintering (SLS) or via multi-jet fusion (MJF).

Regarding selective laser sintering (SLS), any machine can be used for printing the three-dimensional shaped article. One possible approach is to use the EOS P1 with the following two print parameter settings:

The first print parameter setting comprises heating up the process chamber to 107.5° C.+/−1° C., heating up the removal chamber to 52° C., and setting the warm-up time to 70 minutes. For the powder application, a layer thickness of 0.1 mm can be used, while a minimum layer time of 13 seconds is applied. The energy density of the infill (hatching) can be set to 40 mJ/mm², while the speed is 3 000 mm/s, the power is 12 W, and the hatch distance is 0.1 mm. For the contour, a double scanning can be used with an energy density of 33 mJ/mm² where the speed is 3 000 mm/s and the power is 9.9 W.

The second print parameter setting comprises heating up the process chamber to 139° C.+/−1° C., heating up the removal chamber to 116.5° C., and setting the warm-up time to 70 minutes. For the powder application, a layer thickness of 0.1 mm can be used. The energy density of the infill (hatching) can be set to 36 mJ/mm², while the hatch distance is 0.1 mm. For the contour, a double scanning can be used with an energy density of 38 mJ/mm².

Regarding multi-jet fusion (MJF), also any machine can be used for printing the three-dimensional shaped article. For example, the HP JT Fusion 5200 printer, the HP JT Fusion 5210 printer and the HP JT Fusion 5210 Pro can be used. As print parameter settings the print mode of the BASF Ultrasint TPU01 material can be used with the adoption of the fuse layer trailing to 5300.

The resultant three-dimensional shaped articles typically comprise 58.5% to 99.95% by weight of component (A), 0.05% to 1.5% by weight of component (B), 0% to 5% by weight of component (C), 0% to 5% by weight of component (D) and 0% to 30% by weight of component (E), based in each case on the total weight of the three-dimensional shaped article.

The present invention therefore further provides a three-dimensional shaped article comprising the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c).

The three-dimensional shaped articles are preferably lattices, cushioning, seats, mattresses, protective gear, helmet, shoes, shoe soles and midsoles of shoes.

The three-dimensional shaped article preferably comprises in the range from 73.3% to 99.9% by weight of component (A), in the range from 0.1% to 1.2% by weight of component (B), in the range from 0% to 3% by weight of component (C), in the range from 0% to 2.5% by weight of component (D) and in the range from 0% to 20% by weight of component (E), based in each case on the total weight of the three-dimensional shaped article.

The three-dimensional shaped article most preferably comprises in the range from 74.9% to 99.8% by weight of component (A), in the range from 0.2% to 1.1% by weight of component (B), in the range from 0% to 1.5% by weight of component (C), in the range from 0% to 2.5% by weight of component (D) and in the range from 0% to 20% by weight of component (E), based in each case on the total weight of the three-dimensional shaped article.

The three-dimensional shaped article particularly preferably comprises in the range from 75.4% to 99.75% by weight of component (A), in the range from 0.25% to 1.0% by weight of component (B), in the range from 0% to 1.1% by weight of component (C), in the range from 0% to 2.5% by weight of component (D) and in the range from 0% to 20% by weight of component (E), based in each case on the total weight of the three-dimensional shaped article.

It is clear for a skilled person that the percentages by weight of components (A), (B), (C), (D) and (E) typically add up to 100% by weight.

If the three-dimensional shaped article comprises component (C), it may comprise, for example, in the range from 0.1% to 5% by weight of component (C), preferably in the range from 0.1% to 3% by weight of component (C), more preferably in the range from 0.3% to 1.5% by weight of component (C), and particularly preferably in the range from 0.5% to 1.1% by weight of component (C), based on the total weight of the three-dimensional shaped article.

If the three-dimensional shaped article comprises component (D), it may comprise, for example, in the range from 0.1% to 5% by weight of component (D), preferably in the range from 0.2% to 2.5% by weight of component (D), based on the total weight of the three-dimensional shaped article.

If the three-dimensional shaped article comprises component (E), it may comprise, for example, in the range from 5% to 30% by weight of component (E), preferably in the range from 10% to 20% by weight of component (E), based on the total weight of the three-dimensional shaped article.

If the three-dimensional shaped article comprises component (C), component (D) and/or component (E), the percentages by weight of the at least one thermoplastic polyurethane (A) present in the three-dimensional shaped article are typically correspondingly reduced, such that the sum total of the percentages by weight of the at least one thermoplastic polyurethane (A) and of component (B), and of component (C), of component (D) and/or of component (E) adds up to 100% by weight.

If the three-dimensional shaped article comprises components (C) and (D), it thus comprises, for example, in the range from 58.5% to 99.75% by weight of component (A), in the range from 0.05% to 1.5% by weight of component (B), in the range from 0.1% to 5% by weight of component (C), in the range from 0.1% to 5% by weight of component (D) and in the range from 0% to 30% by weight of component (E), based on the total weight of the three-dimensional shaped article.

In general, component (A) is the component (A) that was present in the sinter powder (SP). It is likewise the case that component (B) is the component (B) that was present in the sinter powder (SP), component (C) is the component (C) that was present in the sinter powder (SP), component (D) is the component (D) that was present in the sinter powder (SP), and component (E) is the component (E) that was present in the sinter powder (SP).

If step i-1) has been conducted, the three-dimensional shaped article additionally typically comprises residual constituents of the fusing agent.

It is clear to the person skilled in the art that, as a result of the exposure or heating of the sinter powder (SP), components (A), (B), and, optionally, (C), (D) and (E) can enter into chemical reactions and be altered as a result. Such reactions are known to those skilled in the art.

Preferably, components (A), (B), and, optionally, (C), (D) and (E) do not enter into any chemical reaction on exposure in step ii); instead, the sinter powder (SP) merely melts.

1.-14. (canceled)

15. A sinter powder (SP) comprising the following components
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c) and
wherein component (a) is selected from the group consisting of hexamethylene 1,6-diisocyanate (HDI) and dicyclohexylmethane 2,2′-diisocyanate (H12 MDI).

16. The sinter powder (SP) according to claim 15, wherein the at least one flow agent (B) is selected from the group consisting of silicon dioxide, silicates, silicas, metal oxides, minerals, borates, phosphates, sulfates and carbonates.

17. The sinter powder (SP) according to claim 15, wherein the sinter powder (SP) comprises
i) 73.3% to 99.9% by weight of component (A), based in each case on the sum total of the percentages by weight of (A), (B), (C), (D) and (E), and/or
ii) 0.1% to 1.2% by weight of component (B), based in each case on the sum total of the percentages by weight of (A), (B), (C), (D) and (E), and/or
iii) 0% to 3% by weight of component (C), based in each case on the sum total of the percentages by weight of (A), (B), (C), (D) and (E), and/or
iv) 0% to 2.5% by weight of component (D), based on the sum total of the percentages by weight of (A), (B), (C), (D) and (E), and/or
v) 0% to 20% by weight of component (E), based on the sum total of the percentages by weight of components (A), (B), (C), (D) and (E).

18. The sinter powder (SP) according to claim 15, wherein the at least one organic additive (C) is selected from the group consisting of polyethylene waxes, polypropylene waxes, maleic acid- and/or maleic anhydride-grafted polypropylene waxes, amide waxes, fatty acid esters and glycerol fatty acid esters.

19. The sinter powder (SP) according to claim 15, wherein the sinter powder (SP)
i) has a particle size (D50) in the range from 10 to 150 μm, wherein the particle size (D50) is determined by means of laser diffraction according to ISO 13320: 2020-01, and/or
ii) has a melting temperature (T_{M(SP), H1}) in the range from 90 to 220° C., wherein the melting temperature (T_{M(SP), H1}) is determined according to DIN EN ISO 11357-3: 2018-04 by means of differential scanning calorimetry, and/or
iii) has a bulk density in the range from 250 to 700 g/L, wherein the bulk density is determined according to DIN EN ISO 60: 2000-01, and/or
iv) is prepared by grinding, by precipitation, by melt emulsification or by microgranulation.

20. The sinter powder (SP) according to claim 15, wherein as component (b)
i) polyols are used, wherein the content of polyols, which are not polyether polyols, is ≤15 wt.-%, based on the total weight of the polyols, or
ii) polyols are used, wherein the content of polyols, which are not polyester polyols, is ≤15 wt.-%, based on the total weight of the polyols.

21. The sinter powder (SP) according to claim 15, wherein the at least one further additive (D) is selected from the group consisting of antinucleating agents, stabilizers, conductive additives, end group functionalizers, dyes, antioxidants, flame retardants and color pigments.

22. The sinter powder (SP) according to claim 15, wherein the at least one reinforcer (E) is selected from the group consisting of carbon nanotubes, glass beads and aluminum silicates.

23. A method of producing a sinter powder (SP) comprising the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c),
comprising the step of
a) grinding the total amount, based on the total weight of the sinter powder (SP), of component (A),
wherein a first portion (BT1) of the total amount, based on the total weight of the sinter powder (SP), of component (B) and/or, optionally, a first portion (CT1) of the total amount, based on the total weight of the sinter powder (SP), of component (C) are mixed into component (A) prior to step a) to obtain a powder (P), and the remaining portion (BT2) of the total amount of component (B) and/or, optionally, the remaining portion (CT2) of the total amount of component (C) are mixed into the powder (P) after step a) to obtain the sinter powder (SP),
wherein the first portion (BT1) accounts for 0% to 100% by weight of the total amount, based on the total weight of the sinter powder (SP), of component (B) and wherein the first portion (CT1) accounts for 0% to 100% by weight of the total amount, based on the total weight of the sinter powder (SP), of component (C), and wherein the remaining portion (BT2) accounts for (100-BT1)% by weight of the total amount, based on the total weight of the sinter powder (SP), of component (B) and the remaining portion (CT2) accounts for (100-CT1)% by weight of the total amount, based on the total weight of the sinter powder (SP), of component (C),
and wherein optionally
the total amount, based on the total weight of the sinter powder (SP), of component (D) and/or the total amount, based on the total weight of the sinter powder (SP), of component (E) is mixed in before step a) or after step a).

24. A three-dimensional (3D) printing process which comprises utilizing the sinter powder (SP) according to claim 15.

25. A three-dimensional shaped article comprising the following components:
(A) 58.5% to 99.95% by weight, based on the sum total of the percentages by weight of (A), (B), (C), (D) and (E), of at least one thermoplastic polyurethane,
(B) 0.05% to 1.5% by weight, based on the sum total of the percentages by weight of (A), (B), (C), (D) and (E), of at least one flow agent,
(C) 0% to 5% by weight, based on the sum total of the percentages by weight of (A), (B), (C), (D) and (E), of at least one organic additive,
(D) 0% to 5% by weight, based on the sum total of the percentages by weight of (A), (B), (C), (D) and (E), of at least one further additive, and
(E) 0% to 30% by weight, based on the sum total of the percentages by weight of (A), (B), (C), (D) and (E), of at least one reinforcer,
wherein the at least one thermoplastic polyurethane (A) is prepared by reacting at least the following components
(a) at least one isocyanate,
(b) at least one isocyanate-reactive compound, and
(c) at least one chain extender,
wherein components (a), (b) and (c) each comprise not more than 15 mol-% of aromatic moieties, based on the total amount of the respective component (a), (b) and (c).

26. A method of producing a three-dimensional shaped article, comprising the steps of:
i) providing a layer of a sinter powder (SP) according to claim 15, and
ii) exposing or heating the layer of the sinter powder (SP) provided in step i).

27. A three-dimensional shaped article obtained by the method according to claim 26.

28. A three-dimensional (3D) printing process for producing a three-dimensional shaped article to improve the energy return of the three-dimensional shaped article which comprises utilizing the sinter powder (SP) according to claim 15

29. The printing process as claimed in claim 24, wherein the 3D printing process is a sintering process.

30. The printing process as claimed in claim 24, wherein the 3D printing process is a selective laser sintering (SLS) process or in a multi-jet fusion (MJF) process.

31. The printing process as claimed in claim 28, wherein the 3D printing process is a sintering process.

32. The printing process as claimed in claim 28, wherein the 3D printing process is a selective laser sintering (SLS) process or in a multi-jet fusion (MJF) process.
